(19) United States
(12) Patent Application Publication
(10) Pub. No.: US 2022/0010609 A1
(43) Pub. Date: Jan. 13, 2022

(54) FRAME ASSEMBLY

(71) Applicants: John ZUCKER, London (GB); John BRADES, Sawbridgeworth, Hertfordshire (GB)

(72) Inventors: John ZUCKER, London (GB); John BRADES, Sawbridgeworth (GB); Andrew NEW, Hethersett (GB); Adrian TOON, Wrenbury (GB)

(21) Appl. No.: 17/295,697

(22) PCT Filed: Nov. 15, 2019
(86) PCT No.: PCT/GB2019/053234

§ 371 Date: May 20, 2021

(30) Foreign Application Priority Data
Nov. 21, 2018 (GB) 1818966.2

(51) Int. Cl. E06B 3/663; E06B 3/673; E06B 5/10; E06B 5/12; E06B 3/54; F41H 5/26

(52) U.S. Cl. CPC E06B 3/66366; E06B 3/66319; E06B 3/67326; E06B 2003/66395; E06B 5/12; E06B 3/5454; F41H 5/263; E06B 5/106

(57) ABSTRACT

The application describes a frame assembly. The frame assembly comprises: first and second glass panels substantially parallel to each other; and an intermediate ballistic panel positioned between the first and second glass panels. A spacer element is positioned between the first and second glass panels and adapted to receive the intermediate ballistic panel. The spacer element comprises a recess adapted to receive the intermediate ballistic panel therein. The recess is larger than the intermediate ballistic panel in at least one dimension by a tolerance value to accommodate thermal expansion of the intermediate ballistic panel.

### FIELD OF THE INVENTION

This invention relates to an assembly for sheet material, especially plural parallel sheet panels for use in construction.

### BACKGROUND OF THE INVENTION

Panel structures comprising panels of sheet material and using supporting frames are employed in numerous situations, especially in the field of construction. For example, panel structures are used in the fabrication of windows, interior/exterior walls including curtain walling and partition walls, and doors. These structures may use any combination of glass, transparent, semi-transparent, translucent, and/or solid metal/polymer sheets.

The process of manufacturing such panel structures typically comprises providing material in large sheets and cutting these sheets to a particular size that fits a given size of supporting frame. The sheets may then be fitted into the supporting frame(s) using various methods depending on the structure of the frame(s).

Numerous frames are known that accommodate the reception of single sheets of material. A panel structure comprising a single sheet of material supported by a frame is typically referred to as a ‘single panelled’ structure. More recently, frames have also been designed to accommodate more than one sheet of material. As a result, panel structures comprising two generally parallel sheets of material supported by a frame are now widely known and referred to as ‘double panelled’ or ‘double glazed’ structures. Similarly, ‘triple panelled’ and ‘quadruple panelled’ structures have been demonstrated.

For both single-panelled and double-panelled structures, the typical method of installation comprises fitting the sheet material to frame sections, commonly in the form of extruded articles that may be fitted along the peripheral edges of the sheet material. The resultant panel and frame structure may then be mounted in a corresponding receiving structure or framework, such as a wall or roof.

For double panelled structures, especially double-glazed windows, it is known to provide a spacer bar between the two sheets of material to ensure a correct gap between the sheets, and to seal the two sheets together to form a heat or sound barrier (i.e. a sealed unit). Such spacer bars have also been provided with perforations containing desiccant material, which absorb moisture in the trapped air to prevent condensation forming in the space between the sheets. Air can also be replaced with an inert gas such as argon to further improve insulation.

The method steps associated with the manufacture and installation of such panel structures, for example cutting, handling, edge treating, carrying, fixing and installation, in addition to the long term performance of such structures, provide many difficulties. In particular, as a result of the physical attributes of typical panel structures, such as fragility and weight, numerous problems arise. These problems can create deficiencies in, for example, quality, strength, durability and air/water-tightness, and minimising such deficiencies results in additional manufacturing/installation complexity and cost.

Furthermore, panels structures (and their component sheets) used in civil construction may be subjected to sudden impact forces of considerable magnitude or unwanted attempts to remove the sheet material from the supporting framework.

It is, therefore, desirable to realise a supporting frame assembly for sheet material that provides for reduced installation/manufacturing complexity and cost. Furthermore, it is also desirable for such frame assembly to provide significantly improved levels of strength and resistance against impact forces (for example ballistic events and/or bomb blasts) and/or unwanted attempts to remove the sheet material.

### SUMMARY OF THE INVENTION

According to a first aspect of the invention, there is provided a frame assembly comprising: first and second glass panels substantially parallel to each other; an intermediate ballistic panel positioned between the first and second glass panels and comprising a polymeric material; a spacer element positioned between the first and second glass panels and adapted to receive the intermediate ballistic panel, wherein a first portion of the spacer element is positioned between the intermediate ballistic panel and an inner surface of the first glass panel and wherein a second portion of the spacer element is positioned between the intermediate ballistic panel and an inner surface the second glass panel, wherein the spacer element comprises a recess adapted to receive the intermediate ballistic panel therein, and wherein the recess is larger than the intermediate ballistic panel in at least one dimension by a tolerance value to accommodate thermal expansion of the intermediate ballistic panel.

Thus, the invention provides a frame assembly for plural panels that provides high impact resistance. Such a frame assembly may provide sufficient compressive and shear strength to withstand loads induced by: (i) blast pressure waves resulting from the detonation or ignition of explosive or flammable mixtures in proximity to the panels; (ii) wind pressures acting on the panels of sheet material; (iii) small and large projectiles (e.g. bullets, flying debris during extreme weather conditions) impacting the panels; and (iv) unwanted attempts to remove the sheet material (i.e. break-in attempts). Such benefits may also be enabled at reduced installation/manufacturing complexity and cost, when compared to conventional frame assemblies.

Embodiments may be compatible with existing production methods for insulating glazing units, so that the device: (i) can be cut and joined using conventional processing equipment and joining methods (corner cleats etc.); (ii) can be fixed to glazing materials using existing materials (butyl tapes and adhesives, silicone adhesives and sealants, polysulphide adhesives and sealants etc.); and/or (iii) can be effectively sealed with existing sealant systems (primarily polysulphide or silicone formulations).

Also, proposed embodiments may have adequate thermal performance and may not form a significant “cold bridge” between panels of sheet materials.

Embodiments may enable multiple (two, three or more) panels to be connected but at the same time cope with the problem of mismatch of thermal expansion coefficient between panels formed from different materials, which can induce distortion and high stresses in the panels and their connections when the system is subject to temperature variations. The proposed assembly may also allow the thickness of the panels to be varied independently such that the thermal and mechanical properties of the assembly can be tailored to meet specific design requirements.

Unlike a conventional spacer bar (which merely separates the panels within a frame but has no other function), proposed embodiments may employ a structural spacer element that provides the additional function of withstanding high compressive pressure. By withstanding compressive forces (i.e. providing crush resistance), the proposed structural spacer element may prevent an overall thickness of the glazing unit being reduced when under compressive loading. In this way, embodiments may prevent the glazing unit from ‘loss of capture’, where the thickness of the glaze unit is reduced by such an extent that it may come out of the frame. Embodiments may therefore provide improved resilience to edge crushing of the glazing unit.

The dimensions of a spacer element employed by embodiment may be different from conventional spacer bars in that they may be deeper/thicker to take into account the potential pressures they may need to withstand and to hold the panels in place.

Conventional glazing spacer bars are typically divided into two main types: (i) traditional extruded aluminium (or other material) hollow sections, which do not have sufficient compressive strength and have poor thermal characteristics; and (ii) cellular polymer spacers which, while having improved thermal properties, do not have sufficient compressive strength.

The inventors have developed a structural spacer element which helps to provide the advantages outlined above.

In some embodiments, the spacer element may comprise high density polyurethane foams, which may provide high compressive strength and low thermal conductivity. Calculations may be performed to analyse the transfer of load from glazing panel to frame during blast and other events to determine the spacer element dimensions and/or materials properties in order to meet loading requirements.

In other embodiments, the spacer element may comprise a polymeric extruded element. This may lend itself well to conventional production methods and may be simple to manufacture at (or near) the shape and/or dimensions necessary for glazing applications. In particular, spacer elements formed from hollow polymeric extrusions may be preferable. However, it is noted that the spacer element may comprise extrusions formed from composites or even metal.

A spacer element comprising a hollow extruded section may have the following useful properties: (i) high bending stiffness at low mass for bending directions normal to the long axis of the section; (ii) an ability to be joined using “cleat” type fittings, wherein such joints may be linear, perpendicular or at other angles according to the design of cleat to facilitate the manufacture of square, rectangular, polygonal or curvilinear assemblies without extensive preparation of the ends of the sections or the use of welding methods (which are expensive, require specialist equipment and are difficult to check for quality); (iii) reduced thermal transmittance due to the presence of voids/cavities within the cross section; and/or (iv) load calculations may be performed to determine the shape and amount of material necessary in the cross section to meet the loading requirements. Thus, in addition to providing improved (e.g. increased) resistance to compressive forces, a proposed spacer element may also adhere to other requirements. For instance, a spacer element according to a proposed embodiment may be thermally efficient. By way of further example, a proposed spacer element may also be lightweight and economical to manufacture.

Variations of the design (e.g. the amount of material in the cross section and/or the shape, size and direction of a dividing element separating first and second passages extending longitudinally through the spacer element) can be introduced to accommodate different requirements. Such requirements may, for example, relate to loading requirements, heat transfer characteristics, the stiffness of the window in the direction normal to the panels in the case of contact between panels at or around the centre of the window, or the resistance to penetration by projectiles, etc. Various features of the proposed spacer element may enable a required stiffness (i.e. resistance to deflection under load) and strength (i.e. resistance to failure by yielding or fracture under load) to be achieved, whilst also maintaining thermal efficiency, and economic manufacturability.

Such features may include the transverse section(s) (i.e. dividing element(s)) forming the top and bottom (and possibly middle) of a cavity (or cavities) of the spacer element. For instance, the in-plane (with respect to the glazing unit) separation of the transverse sections may be designed so as to ensure that the spacer can resist the bending moments generated by the flexure of the glazing panels (typically just the outer panel in the early stages of blast loading).

By way of example, for a frame assembly for holding two glazing units, the spacer element may have dimensions of 27 mm in height, the height being measured in-plane with the glazing unit, by 15.5 mm in width, the width being measured perpendicular to the height, i.e. in line with the thickness of the glazing unit. These dimensions may provide a glazing unit separation of 16 mm (with adhesive allowance). The spacer element may have a wall thickness of 2 mm.

Of course, the dimensions of the space element may be altered according to the application. Accordingly, the spacer element may have an aspect ratio, the aspect ratio being defined as the ratio between the height and the width as defined above, in the range of 1.0 to 3.0, for example in the range of 1.5 to 2.0. For example, the aspect ratio may be 1.75.

For frame assemblies for holding more than two glazing units, the dimensions of the spacer element would increase accordingly, for example to provide glazing unit separations of 16mm between each glazing unit.

For example, for a frame assembly for holding three glazing units, the spacer element may have a height of 27 mm and a width of 45.5 mm. In this instance, the aspect ratio of the spacer element may be in the range of 0.2 to 1.5, for example in the range of 0.5 to 1.0. For example, the aspect ratio may be 0.6.

In a further example, for a frame assembly for holding four glazing units, the spacer element may have a height of 27 mm and a width of 77 mm. In this instance, the aspect ratio of the spacer element may be in the range of 0.1 to 1.0, for example in the range of 0.3 to 0.5. For example, the aspect ratio may be 0.35.

Embodiments may further comprise: an intermediate glass panel positioned between the intermediate ballistic panel and the first glass panel and being substantially parallel to the first glass panel; and a second spacer element positioned between the first glass panel and the intermediate glass panel. In this way, a four-panelled (i.e. quadruple-panelled) assembly may be provided which has been found to be particularly beneficial in terms of blast resistance and ballistic event resistance. For instance, such an embodiment may employ the concept of combining a triple-panelled assembly according to an embodiment (which provides improved blast resistance) with an additional panel (and spacer) so as to obtain improved resistance to ballistic events. The additional panel may, for example, absorb additional energy from an incident projectile and thus prevent the projectile from breaching the intermediate ballistic panel.

Accordingly, it is to be appreciated the proposed embodiments may be combined with additional panels in a manner which provides further advantages whilst also maintaining the benefit of reduced installation/manufacturing complexity.

Thus, the invention provides a frame assembly for plural panels that provides high impact resistance. Such a frame assembly may provide sufficient compressive and shear strength to withstand loads induced by: (i) blast pressure waves resulting from the detonation or ignition of explosive or flammable mixtures in proximity to the panels; (ii) wind pressures acting on the panels of sheet material; (iii) small and large projectiles (e.g. bullets, flying debris during extreme weather conditions) impacting the panels; and (iv) unwanted attempts to remove the sheet material (i.e. break-in attempts). Such benefits may also be enabled at reduced installation/manufacturing complexity and cost, when compared to conventional frame assemblies.

Embodiments may further comprise: a first inner frame section fitted to an outer surface of the first glass panel, wherein the outer surface of the first glass panel is opposite the inner surface of the first glass panel; and a second, separate inner frame section fitted to an outer surface of the second glass panel, wherein the outer surface of the second glass panel is opposite the inner surface of the second glass panel.

Thus, a frame assembly according to a proposed embodiment may provide improved levels of resistance against sudden impact forces and/or unwanted attempts to remove or break through the panels of sheet material. By applying an inner frame section (referred to by the Applicant as “Edge Retention Profile”) near the edge of the outer face of the glass panels, a combined cross-sectional shape can be formed wherein the cross-sectional shape is designed to create, form or otherwise define a space for receiving a projection of an outer frame section. Thus, the space and received projection may cooperate to hinder relative lateral and/or vertical movement. In this way, lateral and vertical movement of the glass panels fitted to the inner frame section may be hindered or prevented when an outer frame section receives the panels with the inner frame sections fitted thereto. Also, externally applied forces may be distributed over the surface of the inner frame sections.

It is also noted that the inner frame sections may increase an available area for bonding to the sheet material than would otherwise be available.

Proposed concepts may also help to eliminate or relieve a need for specialist installation personnel. Further, embodiments may avoid the need to apply silicone or wet sealant/adhesive between the glass panels and the frame, enabling installation time to be reduced. Eliminating a need for silicone or wet sealant/adhesive application also addresses the problem that application can typically only be done in dry and warm conditions.

Proposed embodiments may provide a system which moves quality requirements towards the manufacturing stage(s), rather than relying on unpredictable or variable results due to the application of ‘wet’ products on site. For example, inner frame sections may be fitted to panels in a controlled manufacturing environment (which may have specialist equipment available for example) so as to facilitate accurate and high-quality products that are adapted and ready to be installed into (e.g. received by) outer frame sections.

The frame assembly may be fully “bi-directional” in its performance. That is, it may be able to withstand a bomb blast in both directions (it should be noted here that the shock waves caused by bomb blasts do generate inward and outward forces on a window).

In addition, the frame assembly may provide the ability to accommodate new (replacement) sealed structures of different sizes (length or width). For example, embodiments may cater for the insertion of ballistic resistant or break-in resistant sheets of material in straight-forward manner. Such additional sheets of material may be made from a polymeric material, such as (but not limited to) polycarbonate, PETG or acrylic for example. Also, composite panels containing mixed materials bonded together may be employed.

By way of further example, the intermediate ballistic panel may comprise ballistic resistant material. Such ballistic resistant materials may be widely-known and may, for instance, include a polymeric material such as polycarbonate. The ballistic resistant material may therefore comprise a non-amorphous polymer. By way of further example, materials such as polycarbonate, ABS or other thermoplastics, in solid or cellular cross-sectional form could be used for the spacer element.

With some embodiments, frames may be adapted to accommodate changes of sheet material thickness or change in the number of panels of sheet material without having to remove the frames from the wall, and with full access from the inside of the building.

Employing glass panels in combination an intermediate ballistic panel (e.g. formed from a polymeric material) may pose the issue that the thermal expansion coefficient between the panels do not match (e.g. because they are formed from different materials). Proposed embodiments may address this issue by employing a spacer element that has a recess adapted to receive the intermediate ballistic panel therein, wherein the recess is larger than the intermediate ballistic panel in at least one dimension by a tolerance value. This may enables the intermediate ballistic panel to be provided in (what may be thought of as) a ‘floating arrangement’, wherein the room/space is provided between the intermediate ballistic panel and the recess so as to cater for thermal expansion of the intermediate ballistic panel.

By way of example, the tolerance value may be greater than or equal to 5 mm, and may, in some embodiments, be greater than or equal to 10 mm. By being larger than the received projection, the space may not only cater for manufacturing and/or installation variations, but may also provide room for expansion of the intermediate ballistic panel.

The first inner frame section and the first projection of the outer frame section may be adapted to have complementary or interlocking geometries.

In an embodiment, the first inner frame section may have an S-shaped or Z-shaped cross-sectional shape. Such an inner frame section may be formed via extrusion and/or bending of an elongated element.

In another preferred version, the space of the first inner frame section may be larger than the received first projection in at least one dimension by a tolerance value. By way of example, the tolerance value may be greater than or equal to 5 mm, and may, in some embodiments, be greater than or equal to 10 mm. By being larger than the received projection, the space may cater for manufacturing and/or installation variations. Also, room for expansion of the material(s) may be provided.

In an embodiment, the outer frame section may have a mouth portion into which the sheet material with the inner frame section fitted thereto is adapted to be received, and the sheet material with the inner frame section fitted thereto may be wider than the mouth portion.

The cross-sectional shape of the outer frame section may be substantially U-shaped. To enhance a frictional grip, there may be roughened or serrated surfaces on abutting faces of the inner frame sections and outer frame section. Such serration could be fine or delicately indented/patterned, and the faces may have matching indentations.

In some embodiments, the first inner frame section may comprise a removed corner portion which defines the space adapted to receive the first projection of the outer frame section. Also, the removed corner portion may define a recess or seat along the longitudinal length of the first inner frame section, and the first projection of the outer frame section may comprise a lip which, when received by the space, engages over the recess or seat. The lip can be useful in preventing access and preventing the first inner frame section (and the sheet material fitted thereto) from being lifted out of the outer frame section.

In an embodiment, the first inner frame section may comprise a groove, or series of grooves, which defines the space adapted to receive a respective projection, or projections, of the outer frame section, the projection(s) comprising a tongue or tongues.

The outer frame section may comprise a pocket or recess adapted to receive the panels with the first and second inner frame section fitted thereto, and the cross-sectional shape of the pocket may be adapted to substantially match that of the panels with the first and second inner frame section fitted thereto. Such an arrangement may reduce the ability of an inner frame section to be levered out of the internal space (e.g. pocket or recess) within which the outer frame section receives the panels (with the first and second inner frame section fitted thereto). To lever an inner frame section from its assembled position, one would have to prise apart the inner frame section from the outer frame section along its perimeter. Such an action is seriously impeded since any rigid implement used to provide a levering force would be unable to ‘wrap’ around the perimeter of the inner frame section in order to separate it from the outer frame section.

In an embodiment, the outer frame section may comprise a second projection, and the second inner frame section may define a space adapted to receive the second projection of the outer frame section, whereby the space of the second inner frame section cooperates with the received second projection to restrict movement of the second inner frame section relative to the outer frame section.

The first inner frame section may be adapted to be fitted to first peripheral portion of the outer surface of the first panel, wherein the first peripheral portion is adjacent a peripheral edge of the first panel. Further, the second inner frame section may be adapted to be fitted to a second peripheral portion of the outer surface of the second panel, wherein the second peripheral portion is adjacent a peripheral edge of the second panel. Also, the outer surface of the second panel may be adapted to face in an opposite direction to that of the outer surface of the first panel.

Thus, there may be provided an inner frame section (or Edge Retention Profile) for fitting to an outer planar surface of a glass panel, preferably near a peripheral edge of the panel of sheet material. By being adapted to be fitted to a glass panel, an inner frame section may be adapted to provide a particular cross-sectional shape when fitted. The cross-sectional shape that results from fitting the inner frame section to a glass panel may be designed so as to provide a geometry or shape that is adapted to substantially match or complement that of an outer frame section. For example, the first inner frame section may define a space or recess that is adapted to receive a respective projection of an outer frame section when the first inner frame section and outer frame section are brought or fitted together. By receiving the projection, the matching or complementary shapes of the space/recess and the projection may cooperate so as to restrict, hinder or prevent movement of the first inner frame section relative to the outer frame section. Such an inner fram section may be applied to all four sides of a panel, or alternatively, three sides, two sides or even just one side

The space of the first inner frame section and the projection of an outer frame section may be adapted to have complementary or interlocking geometries. Substantially matching geometries may thus be employed for the inner and outer frame sections so as to form an interconnection which hinders or prevents an inner frame section(s) from being removed from the outer frame section.

The frame assembly may be a window with single frame, a single composite window carrying plural panels of sheet material, a curtain wall facade or door frame assembly and the sheet material may be at least semi-transparent. There may thus be provided a multi-panelled assembly. The use may be in a wall, floor or overhead assembly. Further, proposed concepts may enable a sealed unit to be formed which is desirable for heat and sound insulation. It is envisaged that adapting an outer frame section to receive one, two, three or more parallel sheets or panels (with inner frame sections fitted to outer surfaces) will be of particular advantage. Further to this, some inner frame sections may also be provided with moisture absorbing means therebetween. In this way, condensation can be prevented from forming in the space between sheets/panels.

The inner frame sections and the outer frame section may be made of aluminium, steel, UPVC, fibre-reinforced cement, plastic or other polymer or metal material.

In preferred embodiments of the invention, one can apply much greater compressive or impact forces than in conventional systems, as the outer frame contacts (and thus applies force/pressure to) the inner frame sections rather than the sheet material (which may include glass for example).

The outer cross-sectional shape of the outer frame section may be substantially U-shaped. However, the cross-sectional shape of the outer frame section may instead be selected from circular, regular polygonal and irregular polygonal.

A window, curtain wall, roof or door frame assembly may be provided by the invention. Thus, in such an assembly the glass panels may be clear, opaque, translucent or otherwise.

By way of example, the inner and/or outer frame sections may be made of aluminium, steel or other metals. Alternatively, they may be formed from UPVC or other plastics or a polymer material. Of course, the inner and outer frame sections may also be formed from any combination of these materials.

Although the above discussion might suggest that the frame assembly is made up of section lengths fitted around the sides of a panel, with corner pieces potentially completing the inner frame, the inner frame sections could have mitred ends if so desired, as with the outer frames. Furthermore, the inner frame sections could extend around a corner of the panels so that in one embodiment the inner frame is made up of four L-shaped inner frame sections (that may be thought of as corner pieces). Thus, if a corner piece extends along a significant length of the panels, then functionally it may be considered as an “inner frame section” within the terms of the invention as defined herein.

According to yet another aspect of the invention, there is provided a spacer element for a frame assembly comprising first and second glass panels substantially parallel to each other and further comprising an intermediate ballistic panel positioned between the first and second glass panels and comprising a polymeric material, the spacer element being adapted to be positioned between the first and second glass panels and adapted to receive the intermediate ballistic panel, wherein a first portion of the spacer element is positioned between the intermediate ballistic panel and an inner surface of the first glass panel and wherein a second portion of the spacer element is positioned between the intermediate ballistic panel and an inner surface the second glass panel, and wherein the spacer element comprises a recess adapted to receive the intermediate ballistic panel therein, the recess being larger than the intermediate ballistic panel in at least one dimension by a tolerance value to accommodate thermal expansion of the intermediate ballistic panel.

Also, the spacer element may comprise a hollow polymeric extruded element.

Further, the spacer element may comprise first and second passages extending longitudinally therethrough and separated by a dividing element. The dividing element may, for example, be substantially planar and preferably lies in a plane extending through the first and second glass panels.

In an embodiment, the tolerance value may be greater than or equal to 5 mm.

In some embodiments, the outer cross-sectional shape of the spacer element may be substantially U-shaped.

According to another aspect of the invention, there is provided a method of constructing a frame assembly having plural parallel panels, the method comprising: arranging first and second glass panels substantially parallel to each other; positioning an intermediate ballistic panel between the first and second glass panels, the intermediate ballistic panel comprising a polymeric material; receiving the intermediate ballistic panel in a recess of a spacer element, the recess being larger than the intermediate ballistic panel in at least one dimension by a tolerance value to accommodate thermal expansion of the intermediate ballistic panel; and positioning a spacer element between the first and second glass panels such that a first portion of the spacer element is positioned between the intermediate ballistic panel and an inner surface of the first glass panel and such that a second portion of the spacer element is positioned between the intermediate ballistic panel and an inner surface the second glass panel, wherein the outer surface of the second glass panel is opposite the inner surface of the second glass panel.

### BRIEF DESCRIPTION OF THE DRAWINGS

Examples of the invention will now be described in detail with reference to the accompanying drawings, in which:

FIG. 1 illustrates a cross-sectional view of a frame assembly according to an embodiment, wherein the left-hand side of the diagram is the external/outside facing side;

FIG. 2 illustrates the embodiment of FIG. 1 received by an outer frame section;

FIGS. 3A-3D show various modifications to the spacer employed in the embodiments of FIGS. 1 and 2;

FIG. 4 depicts another modification to the spacer element of FIGS. 1 and 2; and

FIG. 5 illustrates a cross-sectional view of a frame assembly according to another embodiment, wherein the left-hand side of the diagram is the external/outside facing side.

### DETAILED DESCRIPTION

The following description provides a context for the description of elements and functionality of the invention and of how elements of the invention can be implemented.

It should be understood that the Figures are merely schematic and are not drawn to scale. It should also be understood that the same reference numerals are used throughout the Figures to indicate the same or similar parts.

Proposed are concepts for reducing installation/manufacturing complexity and cost of a frame assembly for plural panels of sheet material.

Also proposed are concepts for improving the blast, break-in and/or impact resistance of a frame assembly. Such improvements may be realised by the use of an intermediate ballistic layer between a pair of parallel glass panels. The intermediate ballistic layer may be supported by a spacer element which is adapted to resist compression and/or transfer forces to/from the intermediate ballistic layer. The spacer element may further support the intermediate ballistic layer in a ‘floating arrangement’, wherein the spacer element receives the intermediate ballistic layer in a recess that is sized (e.g. larger than the intermediate ballistic layer in at least one dimension) to accommodate thermal expansion of the intermediate ballistic layer. In this way, the different coefficients of thermal expansion for the glass panels and the intermediate ballistic layer may be catered for, thus reducing distortion and high stresses in the panels and their connections when subjected to temperature variations.

Embodiments may also be at least partly based on the insight that supplementary articles/unit may be attached to a surface of the glass panels so as to provide a predetermined/desired cross-sectional shape. The resultant cross-sectional shape of a glass panel and attached article/unit may be designed to receive a projection of an outer frame section. In other words, the resultant cross-sectional shape of the glass panel and attached article/unit may have a geometry that complements or matches that of an outer frame section. The matching or complementary shapes may then cooperate to restrict or prevent relative movement of the article/unit and the outer frame section. In this way, outer frame sections may be applied to glass panels to securely position and hold the glass panels within a frame.

Embodiments may thus employ the concept that a substantially flat, planar surface of a glass panel can be converted to provide a recess or space for providing an interlocking arrangement, and the conversion may be achieved by fitting or attaching a specifically shaped/designed article/unit to the flat, planar surface of the glass panel.

Illustrative embodiments may be utilised in many different types of frame assemblies, including window frames, curtain walls, roof glazing, door frames, partitions, barriers, etc.

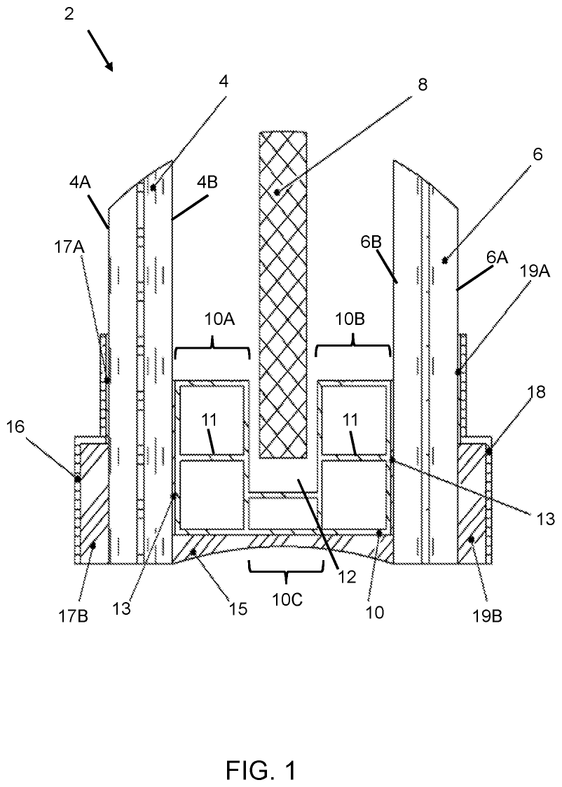

Referring to FIG. 1, there is depicted a frame assembly 2 according to an embodiment of the invention. Here, the frame assembly 10 is for securely holding three substantially parallel panels of sheet material. Also, the left-hand side of the diagram is assumed to be an external/outside facing side.

For the avoidance of doubt, and for an improved understanding, reference to a panel, sheet panel, or single sheet/panel of sheet material should be taken to refer to a panel of sheet material which comprises a body (or panel) defined by opposing surfaces, and one or more peripheral edges extending between the opposing surfaces, the opposing surfaces terminating at the one or more peripheral edges. The peripheral edge(s) therefore define the outer perimeter of the flat body (or panel). Reference to a peripheral portion of a surface of a panel (or panel of sheet material) should therefore be taken to refer to a portion of the surface that is situated adjacent a peripheral edge of the sheet panel. In this way, a peripheral portion of a surface will therefore be understood as being located at or near the edge of the surface, such that a boundary of the peripheral portion co-locates with a peripheral edge or is situated very close to a peripheral edge (i.e. is only separated from the peripheral edge by a small distance e.g. less than 10 cm, preferably less than 5 cm, even more preferably less than 2 cm, and yet more preferably less than 1 cm). Although it is envisaged that the opposing surfaces may be substantially planar (so that the body is substantially flat for example), it that embodiments are foreseen wherein the opposing surfaces are not planar but are instead curved, convex, concave or the like.

The frame assembly 2 comprises first 4 and second 6 glass panels that are arranged to be spaced apart and substantially parallel to each other. The frame assembly also comprises an intermediate ballistic panel 8 positioned between the first and second glass panels and comprising a polymeric material (such as polycarbonate for example).

A spacer element 10 is positioned between the first 4 and second 6 glass panels and adapted to receive the intermediate ballistic panel 8. More specifically, the spacer element 10 is positioned such that a first portion 10A of the spacer element 10 is positioned between the intermediate ballistic panel 8 and an inner surface 4B of the first glass panel 4 and such that a second portion 10B of the spacer element 10 is positioned between the intermediate ballistic 8 panel and an inner surface 6A the second glass panel 6.

The spacer element 10 helps to maintain the separation between the glass panels 4, 6 and provides resistance to compressive forces. It may therefore be preferable for the structural spacer element 10 to be designed to withstand high loads (e.g. to withstand the same loads as the frame assembly). By way of example only, the spacer element 10 may be formed from monolithic material that is chosen for its compressive strength and low heat conductivity properties. Alternatively, the spacer element 10 may be formed from a composite material that is designed and/or chosen so as to provide the required compressive strength and heat conductivity properties.

For instance, the spacer element 10 may be made of a range of materials which provide a structural strength of at least 90 N per mm of length and a low thermal conductivity to minimise thermal bridging. Materials such as polycarbonate, ABS or other thermoplastics, in solid or cellular cross-sectional form could be used.

The spacer element 10 of this example comprises a hollow polymeric extruded element has an outer cross-sectional shape that is generally U-shaped. In particular, the first 10A and second 10B portions of the spacer element 10 are separated from each other by a third portion 10C of the spacer element. The first 10A, second 10B and third 10C portions of the spacer element 10 are of substantially equal horizontal width (i.e. left to right as viewed in FIG. 1), but the third portion 10C of the spacer element 10 is approximately one quarter of the vertical height (i.e. bottom to top as viewed in FIG. 1) of the first 10A and second 10B portions of the spacer element 10.

By way of example, for a frame assembly for holding two glazing units, the spacer element may have dimensions of 27 mm in height, the height being measured in-plane with the glazing unit, by 15.5 mm in width, the width being measured perpendicular to the height, i.e. in line with the thickness of the glazing unit. These dimensions may provide a glazing unit separation of 16 mm (with adhesive allowance). The spacer element may have a wall thickness of 2 mm.

Of course, the dimensions of the space element may be altered according to the application. Accordingly, the spacer element may have an aspect ratio, the aspect ratio being defined as the ratio between the height and the width as defined above, in the range of 1.0 to 3.0, for example in the range of 1.5 to 2.0. For example, the aspect ratio may be 1.75.

For frame assemblies for holding more than two glazing units, the dimensions of the spacer element would increase accordingly, for example to provide glazing unit separations of 16 mm between each glazing unit.

For example, for a frame assembly for holding three glazing units, the spacer element may have a height of 27 mm and a width of 45.5 mm. In this instance, the aspect ratio of the spacer element may be in the range of 0.2 to 1.5, for example in the range of 0.5 to 1.0. For example, the aspect ratio may be 0.6.

In a further example, for a frame assembly for holding four glazing units, the spacer element may have a height of 27 mm and a width of 77 mm. In this instance, the aspect ratio of the spacer element may be in the range of 0.1 to 1.0, for example in the range of 0.3 to 0.5. For example, the aspect ratio may be 0.35.

Further, the first 10A and second 10B portions of the spacer element 10 each comprise first and second passages extending longitudinally therethrough and separated by a dividing element 11. The third portion 10C of the spacer element 10 simply comprises a single passage extending longitudinally therethrough.

The dividing element 11 of each of the first 10A and second portions 10B is substantially planar and lies in a generally horizontal plane extending through the first and second glass panels. The dividing element 11 may therefore be thought of struts or cross-bars that are adapted to provide resistance to compressive forces in the horizontal plane. The passageways (i.e. hollow structures) of the first 10A to third 10C portions of the spacer element, on the other hand, reduce the amount of material employed for the spacer element 10, and may also allow for flexion of the spacer element 10.

The U-shaped outer cross-sectional shape of the spacer element 10 results in the spacer element comprising a recess 12. The recess 12 is adapted to receive the intermediate ballistic panel 8 therein. Further, the recess 12 is larger than the intermediate ballistic panel in at least one dimension by a tolerance value to accommodate thermal expansion of the intermediate ballistic panel 8.

In the example of FIG. 1, it is depicted that the width (i.e. left to right extent as viewed in FIG. 1) of the recess exceeds the left to right extent (i.e. thickness) of the intermediate ballistic panel 8. The extra/additional width (i.e. tolerance value) of the recess 12 compared to the thickness of the intermediate ballistic panel 8 may, for example, be greater than or equal to 3 mm, and preferably in the range of 5 to 20 mm. Alternatively, the extra/additional width (i.e. tolerance value) of the recess 12 compared to the thickness of the intermediate ballistic panel 8 may, for example, be relative to a dimension of the intermediate panel 8, such as 0.1% to 1% of the panel edge dimension, and more preferably in the range of 0.3% to 0.5% of the panel edge dimension.

The spacer element is fitted to the first 4 and second 6 glass panels using a double-sided adhesive tape 13 (such as Very High Bonding tape, for example). Such industrial bonding tapes are known, widely available, and can provide a strong bond between two elements. Using such an adhesive arrangement may help to maintain the position of the spacer element 10. The double-sided adhesive tape 13 securely bonds the spacer element 10 to the first 4 and second 6 glass panels, thus ensuring that the spacer element 10 is bonded tightly to the glass panels 4, 6.

In the embodiment of FIG. 1, a first inner frame section 16 is fitted to an outer surface 4A of the first glass panel 4. The outer surface 4A of the first glass panel 4 is opposite the inner surface 4B of the first glass panel 4. Similarly, a second, separate inner frame section 18 fitted to an outer surface 6A of the second glass panel 6. The outer surface 6A of the second glass panel 6 is opposite the inner surface 6B of the second glass panel.

The first 16 and second 18 inner frame sections may, for example, be made of aluminium, steel, UPVC, plastic or other polymer material. By way of further example only, in the embodiment of FIG. 1, the inner frame sections 16,18 are each formed from aluminium and each have (maximum) thickness of between 2 mm-50 mm. Of course, it will be appreciated that the inner frame sections may be of greater, lesser or varying thickness in alternative embodiments.

In more detail, the first inner frame section 16 comprises an elongate extruded member 16 that is adapted to be fitted to a peripheral portion of the outer surface 4A of the first glass panel 4. As will be understood from the description above, the first peripheral portion is adjacent a peripheral edge of the first glass panel 4. Here, the peripheral edge faces vertically downwards (i.e. is arranged substantially horizontally) in FIG. 1. By way of example, the first inner frame section 16 may be fitted to the first peripheral portion of the outer surface 4A of the first glass panel 4 using any suitable fitting or securing means, including, for example, adhesive, cement, epoxy resin, UV-curing adhesive, screws, rivets, pins, nails, fasteners, bolts, etc. In this example, an adhesive double-sided tape 17A and UV-curing acrylic resin 17B is used.

The second inner frame section 18 comprises an elongate extruded member 18 that is adapted to be fitted to a peripheral portion of the outer surface 6A of the second glass panel 6. The peripheral portion is adjacent a peripheral edge of the second glass panel 6. Here, the peripheral edge of the of the second glass panel faces vertically downwards (i.e. is arranged substantially horizontally) in FIG. 1. Again, by way of example, the second inner frame section 18 may be fitted to the peripheral portion of the outer surface 6A of the second glass panel 6 using any suitable fitting or securing means, including, for example, adhesive, cement, epoxy resin, UV-curing adhesive, screws, rivets, pins, nails, fasteners, bolts, etc. In this example, an double-sided adhesive tape 19A and UV-curing acrylic resin 19B is used.

Finally, a sealant (typically known as a secondary sealant) 15 is provided below the spacer element 10 extending between the first 4 and second 6 glass panels. The sealant 15 is adapted to form a sealed connection between the first 4 and second 6 glass panels (so as to prevent water ingress for example). By way of example only, the sealant 15 may comprise a polysulphide or silicone sealant.

The frame assembly of FIG. 1 may be employed in a window or door frame assembly and the panels may be at least semi-transparent, partially opaque, or translucent. There may be thus be provided a multi-panelled assembly window or door frame assembly. Embodiments may be employed in other assemblies, such as barriers, curtain walling, roof tiling, roof lights, ceilings, suspended ceilings, partition walls, etc. Further, proposed concepts may enable a sealed unit to be formed which is desirable for heat and sound insulation.

It is noted that for embodiments adapted to receive three or more panels, the panels may be provided with moisture absorbing means therebetween. In this way, condensation can be prevented from forming in the space between sheets/panels.

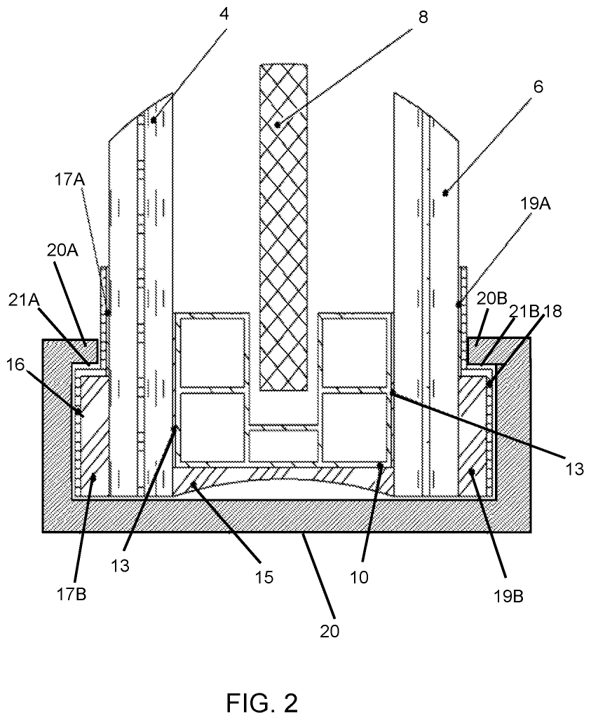

Referring now to FIG. 2, the embodiment of FIG. 1 is depicted in use.

An outer frame section 20 is provided for receiving the panels 4, 6, 8 with the first 16 and second 18 inner frame sections fitted thereto.

The outer frame section comprises first 20A and second 20B projections extending inwardly towards each other. In this example, the first 20A and second 20B projections are each in the form of an inwardly projecting lip 20A, 20B.

The first 16 and second 18 inner frame sections each define a space 21A, 21B adapted to receive a respective projection 20A, 20B of the outer frame section 20, whereby the spaces 21A, 21B of the first 16 and second 18 inner frame sections cooperate with the respective received projections 20A,20B to restrict movement of the received inner frame sections 16,18 relative to the outer frame section 20.

More specifically, in the embodiment of FIG. 2. The first 16 and second 18 inner frame sections each comprise an elongate member that has a cross-sectional shape (e.g. via extrusion or bending) comprising first to third portions. The second portion is between the first and third portions and angled to be perpendicular to the first and third portions (when viewed in cross-section). The first and third portions are substantially parallel to each other (when viewed in cross-section). Thus, the relative arrangement of the first portions of each inner frame section defines a seat or recess along the longitudinal length of each inner frame section 16,18. When received by the respective space 21A, 21B, the lip 20A, 20B engages over the recess or seat. Thus, when the inner frame sections 16,18 (with the panels fitted thereto) are received by the outer frame section 20, the lip 20A,20B prevents the inner frame sections 16,18 (and the panels fitted thereto) from being lifted out of the outer frame section 20.

In this example, the spaces 21A, 21B of first 16 and second 18 inner frame sections and the respective projections 20A, 20B of the outer frame section 20 comprise substantially complementary (i.e. matching) or interlocking geometries. However, it is noted that, in this example, the spaces 21A, 21B of the first 16 and second 18 inner frame sections are adapted to be larger than the respective received projections 20A, 20B in at least one dimension. More specifically, in the embodiment of FIG. 2, the spaces 21A, 21B of the first 16 and second 18 inner frame sections are larger than the respective received projections 20A, 20B in the vertical direction by around 5 mm. This difference in dimension caters for manufacturing tolerances and/or installation variations by providing extra vertical room for the projections 20A, 20B to fit in the respective spaces 21A, 21B. Of course, it will be understood that other values of the size difference may be employed, such as about 10 mm or about 15 mm for example, and the size difference need not be in the vertical direction (e.g. it may be in the horizontal direction, depth direction, or any combination of thereof). The additional space provided by making the spaces 21A, 21B to be larger than the respective received projections 20A, 20B may additionally (or alternatively) be adapted to cater for gradual or sudden expansion of components (such as the inner frame sections and/or the panels of sheet material for example).

In the example embodiment of FIG. 2, the cross-sectional shape of the outer frame section 20 is substantially U-shaped. To enhance a frictional grip, there may be roughened or serrated surfaces on abutting faces of the inner frame sections 16,18 and outer frame section 20. Such serration could be fine or delicately indented/patterned, and the faces may have matching indentations.

It is also noted that the outer frame section 20 of FIG. 2 comprises a mouth portion (defined by the lips 20A, 20B into which the panels 4, 6, 8 (with the inner frame sections 16,18 fitted thereto) are adapted to be received. Due to each lip 20A,20B being adapted to engage over a recess or seat formed in a respective inner frame portion, the mouth portion is narrower than the combined width of the sheet material 12,14 with the inner frame sections 16,18 fitted thereto.

Thus, it will be understood that the cross-sectional shape of the outer frame section 20 defines a pocket or recess adapted to receive the panels with the inner frame sections 16,18 fitted thereto. Furthermore, the inner cross-sectional shape of the pocket (e.g. the cross-sectional shape defined by the inner or inwardly-facing surfaces of the outer frame portion 20) is adapted to substantially match the outer cross-sectional shape of the panels 4, 6, 8 with the inner frame sections 16,18 fitted thereto (e.g. the cross-sectional shape defined by the outer or outwardly-facing surfaces of the combined glass panels 4, 6 and inner frame sections 16,18). Such an arrangement may reduce the ability of an inner frame section to be levered out of the internal space (e.g. the pocket or recess) of the outer frame section 20. To lever an inner frame section from its assembled arrangement (as depicted in FIG. 2), one would have to prise apart the inner frame section from the outer frame section 20 along its perimeter. Such an action is seriously impeded since any rigid implement used to provide a levering force would be unable to ‘wrap’ around the perimeter of the inner frame section in order to separate it from the outer frame section.

Although the embodiment of FIG. 2 has been described as comprising an outer frame section having a substantially U-shaped cross-sectional shape, it should be understood that, in other embodiment, the cross-sectional shape of the outer frame section may be selected from circular, regular polygonal and irregular polygonal.

Although the above description may suggest that a completed frame assembly may be made up of section lengths fitted around the sides of a panel, with corner pieces potentially completing the inner frame, the inner frame sections could have mitred ends if so desired, as with the outer frames. Furthermore, the inner frame sections could extend around a corner of the sheet material so that in one embodiment the inner frame is made up of four L-shaped inner frame sections (that may be thought of as corner pieces). Thus, if a corner piece extends along a significant length of the sheet material, then functionally it may be considered as an “inner frame section” within the terms of the invention as defined herein.

Further, some embodiments may not be employed on every side of a panel. For instance, embodiment may be ‘single sided’ or ‘double sided’ and thus not necessarily form a complete frame around the periphery of the panel(s).

Although the embodiment of FIG. 1 has been depicted and described as employing inner frame sections, other embodiments may be provided without inner frame sections.

Also, although the embodiment of FIG. 1 has been depicted and described as employing inner frame sections each having a removed corner for receiving a lip portion of the outer frame section, it is to be understood that other embodiments may employ other combinations of matching or complementary geometries. For example, in an alternative embodiment, at least one of the first and second inner frame sections may comprise a groove which defines the space adapted receive a respective projection of the outer frame section, the respective projection comprising a tongue. In other words, a tongue and groove arrangement may be employed so that the tongue and groove are adapted to cooperate with each other so as to restrict relative movement between the inner and outer frame sections.

Further, although the embodiment of FIG. 1 has been depicted and described as employing two (i.e. first and second) inner frames sections that define a space for receiving a respective projection of the outer frame section, it is to be understood that other embodiments may employ only one inner frame section that defines a space for receiving a projection of the outer frame section. In other words, a proposed embodiment may comprise a modification to that depicted in FIG. 1 wherein the second inner frame section does not define the space 21B and wherein the outer frame section 20 does not have the second projection 20B. In this way, such an embodiment may employ an inner frame section according to an embodiment along with a second, separate (and potentially generic) inner frame section that does not define a space for receiving a projection of the outer frame section.

Also, although the embodiment of FIG. 1 has been depicted and described as employing an outer frame section that is formed as a single component (e.g. a single elongate extruded member having a generally U-shaped cross-sectional shape), it is to be understood that other embodiments may employ an outer frame section that is formed from two or more components that are brought together so as to capture the inner frame sections and sheet material therebetween. In other words, a proposed embodiment may comprise a modification to that depicted in FIG. 2, the outer frame section is formed from first and second outer frame section portions.

Although the embodiments of FIGS. 1 and 2 have been described as comprising a spacer element having a substantially U-shaped cross-sectional shape, it should be understood that, in other embodiments, the cross-sectional shape of the spacer element may be selected from any regular or irregular polygonal.

Also, spacer elements according to various embodiments may be of different size, shape, material, cross-sectional shape, etc.

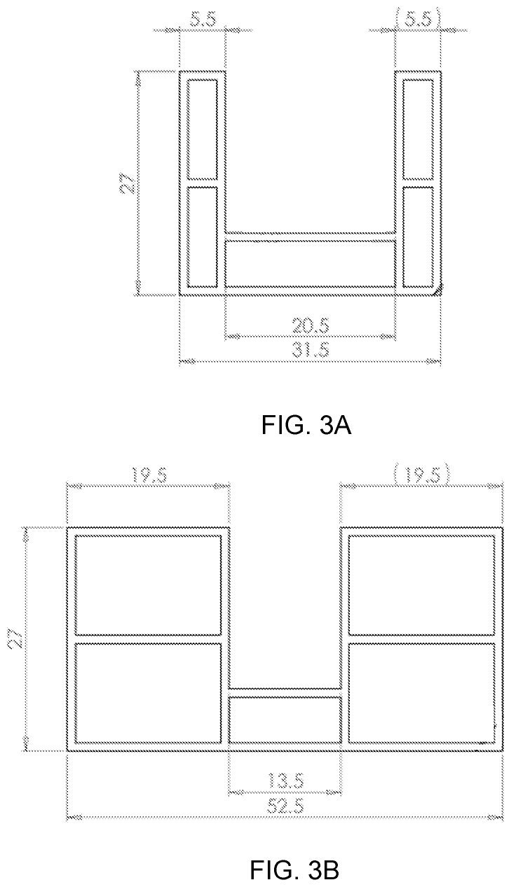

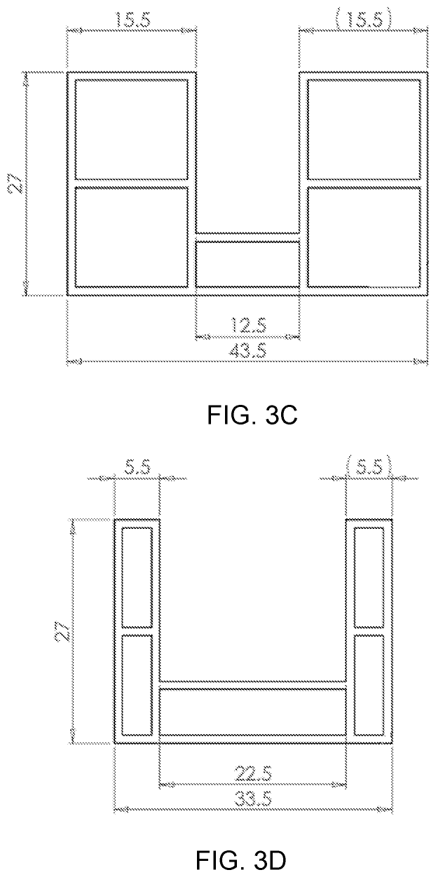

By way of example, referring to FIGS. 3A-3D, there are depicted modifications to the spacer element of FIGS. 1 and 2. FIGS. 3A-3D depict cross-sectional views of various spacer elements, wherein the various dimensions of each spacer element (in mm) are detailed. It will therefore be appreciated the relative size and shape of the first to third portions of the spacer element 10 employed in the embodiments of FIGS. 1-2 may vary in alternative embodiments.

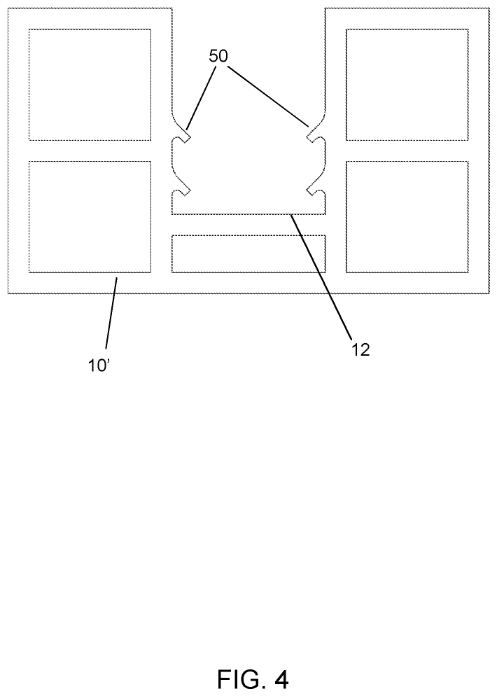

Also, FIG. 4 depicts another modification to the spacer element 10 of FIGS. 1 and 2. More specifically, FIG. 4 depicts a modified spacer element 10′ wherein the recess 12 comprises projections 50 that are configured to prevent a panel received therein from rattling. Such projections 50 are adapted to project from the inner surfaces of the recess 12 in a direction that is angled with respect to the inner surfaces of the recess 12. In this way, the projections 50 may be adapted to ‘flex’ or ‘give’ by a small amount and thus urge against the side panel received in the recess 12.

The projections 50 may prevent or reduce rattling and/or excessive movement of a panel received in the recess 12. The projections 50 may therefore be thought of as “anti-rattle” features that accommodate thermal expansion of a panel received in the recess 12 while reducing free movement of the panel within the recess 12.

It will be understood that the depicted embodiments of FIGS. 3A-3D & 4 are exemplary, and are representative of preferred spacer element designs that have been found to be advantageous (e.g. in terms of their ease of manufacture, strength, weight and/or cost). Such embodiments may, for example, be manufactured by simply extruding an elongate element.

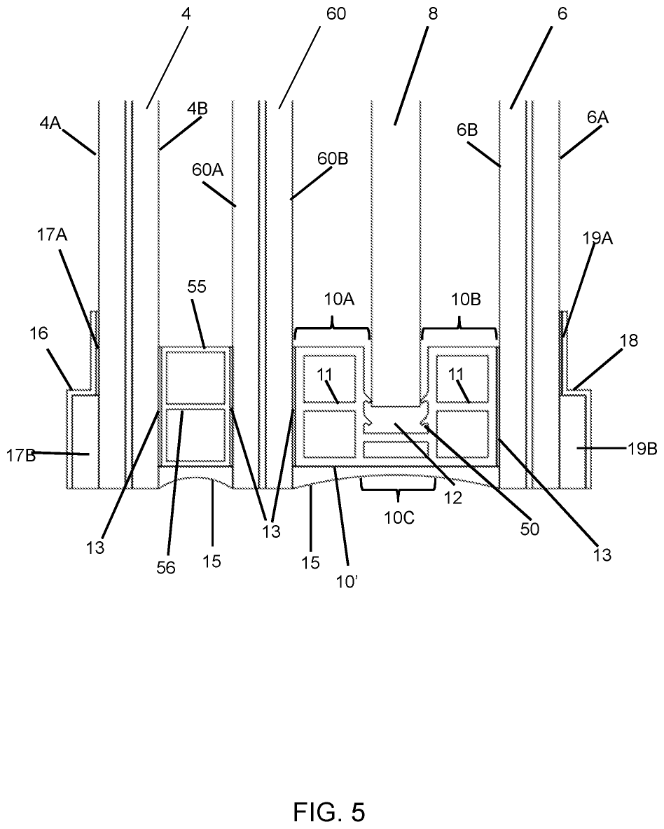

Referring now to FIG. 5, there is depicted a frame assembly according to another embodiment of the invention. Here, the frame assembly is similar to the embodiment depicted in FIG. 1, except that it is configured for securely holding four substantially parallel panels of sheet material. As before, the left-hand side of the diagram is assumed to be an external/outside facing side.

In the similar manner to the embodiment of FIG. 1, the frame assembly of FIG. 5 comprises first 4 and second 6 (outer) glass panels that are arranged to be spaced apart and substantially parallel to each other. The frame assembly also comprises an intermediate ballistic panel 8 positioned between the first 4 and second 6 glass panels and comprising a polymeric material (such as polycarbonate for example). In addition, however, the frame assembly also comprise an intermediate glass panel 60 also positioned between the first 4 and second 6 glass panels. More specifically, the intermediate glass panel 60 is positioned between the first 4 glass panel and the intermediate ballistic panel 8

Accordingly, the spacer element 10 in this embodiment is positioned between the intermediate glass panel 60 and the second 6 glass panel and adapted to receive the intermediate ballistic panel 8. More specifically, the spacer element 10 is positioned such that a first portion 10A of the spacer element 10 is positioned between the intermediate ballistic panel 8 and an inner surface 60B of the intermediate glass panel 60 and such that a second portion 10B of the spacer element 10 is positioned between the intermediate ballistic 8 panel and an inner surface 6B the second glass panel 6.

The spacer element 10 helps to maintain the separation between the glass panels 60, 6 and provides resistance to compressive forces.

The spacer element 10 of this example is similar to that depicted in FIG. 4. Thus, it comprises a hollow polymeric extruded element has an outer cross-sectional shape that is generally U-shaped. In particular, the first 10A and second 10B portions of the spacer element 10′ are separated from each other by a third portion 10C of the spacer element. The first 10A, second 10B and third 10C portions of the spacer element 10′ are of substantially equal horizontal width (i.e. left to right as viewed in FIG. 5), but the third portion 10C of the spacer element 10 is approximately one quarter of the vertical height (i.e. bottom to top as viewed in FIG. 5) of the first 10A and second 10B portions of the spacer element 10′.

Further, the first 10A and second 10B portions of the spacer element 10′ each comprise first and second passages extending longitudinally therethrough and separated by a dividing element 11. The third portion 10C of the spacer element 10 simply comprises a single passage extending longitudinally therethrough.

The dividing element 11 may therefore be thought of struts or cross-bars that are adapted to provide resistance to compressive forces in the horizontal plane. The passageways (i.e. hollow structures) of the first 10A to third 10C portions of the spacer element, on the other hand, reduce the amount of material employed for the spacer element 10′, and may also allow for flexion of the spacer element 10′.

The U-shaped outer cross-sectional shape of the spacer 10′ results in the spacer element comprising a recess 12. The recess 12 is adapted to receive the intermediate ballistic panel 8 therein. The recess 12 is larger than the intermediate ballistic panel in at least one dimension by a tolerance value to accommodate thermal expansion of the intermediate ballistic panel 8. In the example of FIG. 5, it is depicted that the width (i.e. left to right extent as viewed in FIG. 5) of the recess 12 exceeds the left to right extent (i.e. thickness) of the intermediate ballistic panel 8. The extra/additional width (i.e. tolerance value) of the recess 12 compared to the thickness of the intermediate ballistic panel 8 may, for example, be greater than or equal to 3 mm, and preferably in the range of 5 to 20 mm. Alternatively, the extra/additional width (i.e. tolerance value) of the recess 12 compared to the thickness of the intermediate ballistic panel 8 may, for example, be relative to a dimension of the intermediate panel 8, such as 0.1% to 1% of the panel edge dimension, and more preferably in the range of 0.3% to 0.5% of the panel edge dimension.

Furthermore, the recess 12 comprises projections 50 that are configured to prevent a panel received therein from rattling. Such projections 50 are adapted to project from the inner surfaces of the recess 12 in a direction that is angled with respect to the inner surfaces of the recess 12. In this way, the projections 50 extend into the volume of the recess. The projections 50 may also be adapted to ‘flex’ or ‘give’ by a small amount and thus urge against the side of the intermediate ballistic panel 8 received in the recess 12.

The spacer element 10′ is fitted to the intermediate glass panel 60 and the second 6 glass panel using a double-sided adhesive tape 13 with a high bonding strength (such a VHB™ tape for example). Such industrial bonding tapes are known, widely available, and can provide a strong bond between two elements.

In this embodiment, a second spacer element 55 is positioned between the intermediate glass panel 60 and the first glass panel 4. More specifically, the second spacer element 55 is positioned between an outer surface 60A of the intermediate glass panel 60 and an inner surface 4B of the first glass panel 4.

The second spacer element 55 helps to maintain the separation between the first glass panel 4 and the intermediate glass 60 and also provides resistance to compressive forces.

The second spacer element 55 of this example comprises a hollow polymeric extruded element has an outer cross-sectional shape that is generally rectangular-shaped. In particular, second spacer element 55 is similar in size and shape to each of the first 10A and second 10B portions of the spacer element 10′. Thus, second spacer element 55 comprises first and second passages extending longitudinally therethrough and separated by a dividing element 56. The dividing element 56 of the second spacer element 55 may therefore be thought of as a strut or cross-bar that is adapted to provide resistance to compressive forces in the horizontal plane. The passageways (i.e. hollow structures) of the second spacer element 55, on the other hand, reduce the amount of material employed for the second spacer element 55, and may also allow for flexion of the second spacer element 55.

The second spacer element 55 is fitted to the intermediate glass panel 60 and the first glass panel 4 using a double-sided adhesive tape 13 with high adhesive strength (e.g. VHB™ tape).

As before, it may therefore be preferable for the spacer elements 10′, 55 to be designed to withstand high loads (e.g. to withstand the same loads as the frame assembly). By way of example only, the spacer elements 10′, 55 may be formed from monolithic material that is chosen for its compressive strength and low heat conductivity properties. Alternatively, the spacer elements 10′, 55 may be formed from a composite material that is designed and/or chosen so as to provide the required compressive strength and heat conductivity properties.

For instance, the spacer elements 10′, 55 bar may be made of a range of materials which provide a structural strength of at least 90 N per mm of length and a low thermal conductivity to minimise thermal bridging. Materials such as polycarbonate, ABS or other thermoplastics, in solid or cellular cross-sectional form could be used.

In the embodiment of FIG. 5, and in a similar fashion to the embodiment of FIG. 1, a first inner frame section 16 is fitted to an outer surface 4A of the first glass panel 4. The outer surface 4A of the first glass panel 4 is opposite the inner surface 4B of the first glass panel 4. Similarly, a second, separate inner frame section 18 fitted to an outer surface 6A of the second glass panel 6. The outer surface 6A of the second glass panel 6 is opposite the inner surface 6B of the second glass panel.

Like in the embodiment of FIG. 1, the first 16 and second 18 inner frame sections may be made of aluminium, steel, UPVC, plastic or other polymer material. By way of further example only, in the embodiment of FIG. 1, the inner frame sections 16,18 are each formed from aluminium and each have (maximum) thickness of between 2 mm-50 mm. Of course, it will be appreciated that the inner frame sections may be of greater, lesser or varying thickness in alternative embodiments.

By way of example, the first inner frame section 16 may be fitted to the first peripheral portion of the outer surface 4A of the first glass panel 4 using any suitable fitting or securing means, including, for example, adhesive, cement, epoxy resin, UV-curing adhesive, screws, rivets, pins, nails, fasteners, bolts, etc. In this example, an adhesive double-sided tape 17A and UV-curing acrylic resin 17B is used. Again, by way of example, the second inner frame section 18 may be fitted to the peripheral portion of the outer surface 6A of the second glass panel 6 using any suitable fitting or securing means, including, for example, adhesive, cement, epoxy resin, UV-curing adhesive, screws, rivets, pins, nails, fasteners, bolts, etc. In this example, a double-sided adhesive tape 19A and UV-curing acrylic resin 19B is used.

Finally, a sealant (typically known as a secondary sealant) 15 is provided below spacer elements 10′ and 55. The sealant 15 is adapted to form a sealed connection between the first 4 and intermediate 60 glass panels and between the intermediate 60 and second 6 glass panels (so as to prevent water ingress for example). By way of example only, the sealant 15 may comprise a polysulphide or silicone sealant.

The frame assembly of FIG. 5 may be employed in a window or door frame assembly and the panels may be at least semi-transparent, partially opaque, or translucent. There may be thus be provided a quadruple-panelled assembly window or door frame assembly.

It is noted, however, that tests and simulations have demonstrated that the embodiment of FIG. 5 is particularly beneficial in terms of resistance to both blasts and ballistic events. Put another way, the embodiment of FIG. 5 has been shown to be both blast resistant and ‘ballistic-proof’. Investigations have identified that improved resistance to blasts (i.e. blast resistance) may be provided by employing a spacer element as proposed (e.g. because the spacer element provide resistance to compressive forces and helps to prevent contact between the panels during a blast event). Further, the improved resistance to ballistic events may be provided by employing the intermediate panel 60 between the outer panel 4 and the intermediate ballistic panel 8, because the intermediate panel 60 serves as an additional panel which absorbs additional energy from an incident projectile (and potentially alters its path and/or rotation) so that the projectile fails to breach the intermediate ballistic panel 8.

Accordingly, it is to be understood that the embodiment of FIG. 5 may be particularly advantageous for applications where resistance to both blasts and ballistic events is required whilst also allowing for simple/easy assembly and installation.

Embodiments may be employed in other assemblies, such as barriers, curtain walling, roof tiling, roof lights, ceilings, suspended ceilings, partition walls, etc. Further, proposed concepts may enable a sealed unit to be formed which is desirable for heat and sound insulation.

In particular, it is noted that proposed embodiments may be thought of employing a structural spacer element that is adapted to accommodate (i.e. cater for, facilitate) expansion/contraction of the intermediate ballistic layer whilst also supporting or locating the intermediate ballistic layer between a plurality of parallel glass panels. Further, the spacer element may perform a structural function in that it may provide resistance against compressive forces and/or provide an arrangement that reduces stress in the assembly by allowing for some deformation under the sudden application of force (e.g. from a blast, impact or projectile).

For example, the spacer element and/or the inner frame sections may be a carrier for a bonding silicone which allows for movement under loading. To ensure that the bond can be allowed to gain its full strength over a period of fourteen (14) days, the spacer element and/or the inner frame sections may be fitted with a double-sided tape that provides a strong bond (e.g. double-sided VHB™ tape). This may allow immediate handling during the manufacturing process.

Thus, there may be proposed a move from a rigid non-flexible arrangement to a flexible fixing employing a bonding silicone and strong-bond tape so as to allow movement while attaining a great deal of strength over a given failure plane (e.g. movement of up to 20 mm may be catered for).

1. A frame assembly comprising:
first and second glass panels substantially parallel to each other;
an intermediate ballistic panel positioned between the first and second glass panels and comprising a polymeric material; and
a spacer element positioned between the first and second glass panels and adapted to receive the intermediate ballistic panel, wherein a first portion of the spacer element is positioned between the intermediate ballistic panel and an inner surface of the first glass panel and wherein a second portion of the spacer element is positioned between the intermediate ballistic panel and an inner surface the second glass panel,
wherein the spacer element comprises a recess adapted to receive the intermediate ballistic panel therein, and
wherein the recess is larger than the intermediate ballistic panel in at least one dimension by a tolerance value to accommodate thermal expansion of the intermediate ballistic panel.

2. The frame assembly of claim 1, wherein the spacer element comprises a hollow polymeric extruded element.

3. The frame assembly of claim 2, wherein the spacer element comprises first and second passages extending longitudinally therethrough and separated by a dividing element.

4. The frame assembly of claim 3, wherein the dividing element is substantially planar and preferably lies in a plane extending through the first and second glass panels.

5. The frame assembly of claim 1, wherein the tolerance value is greater than or equal to 3 mm.

6. The frame assembly of claim 1, wherein an outer cross-sectional shape of the spacer element is substantially U-shaped.

7. The frame assembly of claim 1, wherein the spacer element is fitted to at least one of the first and second glass panels using double-side tape.

8. The frame assembly of claim 1, further comprising:
an intermediate glass panel positioned between the intermediate ballistic panel and the first glass panel and being substantially parallel to the first glass panel; and
a second spacer element positioned between the first glass panel and the intermediate glass panel.

9. The frame assembly of claim 8, wherein the second spacer element comprises a hollow polymeric extruded element, and optionally wherein the second spacer element comprises first and second passages extending longitudinally therethrough and separated by a dividing element.

10. The frame assembly of claim 8, wherein the second spacer element is fitted to at least one of the first glass panel and the intermediate glass panel using double-side tape.

11. The frame assembly of claim 1, further comprising:
a first inner frame section fitted to an outer surface of the first glass panel, wherein the outer surface of the first glass panel is opposite the inner surface of the first glass panel; and
a second, separate inner frame section fitted to an outer surface of the second glass panel, wherein the outer surface of the second glass panel is opposite the inner surface of the second glass panel.

12. The frame assembly of claim 11, wherein the first and second inner frame sections are fitted to the first and second glass panels, respectively, using double-side tape.

13. The frame assembly of claim 11, further comprising:
an outer frame section for receiving the panels with the first and second inner frame sections fitted thereto, the outer frame section comprising a first projection,
wherein the first inner frame section defines a space adapted to receive the first projection of the outer frame section, whereby the space of the first inner frame section cooperates with the received first projection to restrict movement of the first inner frame section relative to the outer frame section.

14. The frame assembly of claim 11, wherein a cross-sectional shape of the first inner frame section is substantially S-shaped or Z-shaped.

15. The frame assembly of claim 13, wherein the space of the first inner frame section and the first projection of the outer frame section are adapted to have complementary or interlocking geometries.

16. The frame assembly of claim 13, wherein the outer frame section has a mouth portion into which the panels with the first and second inner frame sections fitted thereto is adapted to be received, and wherein the panels with the first and second inner frame sections fitted thereto are wider than the mouth portion.

17. The frame assembly of claim 1, wherein the frame assembly is a window or door frame assembly and the panels are at least semi-transparent.

18. A spacer element for a frame assembly comprising first and second glass panels substantially parallel to each other and further comprising an intermediate ballistic panel positioned between the first and second glass panels and comprising a polymeric material,
the spacer element being adapted to be positioned between the first and second glass panels and adapted to receive the intermediate ballistic panel, wherein a first portion of the spacer element is positioned between the intermediate ballistic panel and an inner surface of the first glass panel and wherein a second portion of the spacer element is positioned between the intermediate ballistic panel and an inner surface the second glass panel,
and wherein the spacer element comprises a recess adapted to receive the intermediate ballistic panel therein, the recess being larger than the intermediate ballistic panel in at least one dimension by a tolerance value to accommodate thermal expansion of the intermediate ballistic panel.

19. The spacer element of claim 18, wherein the spacer element comprises a hollow polymeric extruded element.

20. The spacer element of claim 19, wherein the spacer element comprises first and second passages extending longitudinally therethrough and separated by a dividing element.

21. The spacer element of claim 20, wherein the dividing element is substantially planar and preferably lies in a plane extending through the first and second glass panels.

22. The spacer element of claim 18, wherein the tolerance value is greater than or equal to 3 mm.

23. The spacer element of claim 18, wherein an outer cross-sectional shape of the spacer element is substantially U-shaped.

24. The spacer element of claim 18, wherein the recess comprises one or more projections adapted to contact a surface of an intermediate ballistic panel received within the recess.

25. A method of constructing a frame assembly having plural parallel panels, the method comprising:
arranging first and second glass panels substantially parallel to each other;
positioning an intermediate ballistic panel between the first and second glass panels, the intermediate ballistic panel comprising a polymeric material;
receiving the intermediate ballistic panel in a recess of a spacer element, the recess being larger than the intermediate ballistic panel in at least one dimension by a tolerance value to accommodate thermal expansion of the intermediate ballistic panel; and
positioning a spacer element between the first and second glass panels such that a first portion of the spacer element is positioned between the intermediate ballistic panel and an inner surface of the first glass panel and such that a second portion of the spacer element is positioned between the intermediate ballistic panel and an inner surface the second glass panel.
